(19) United States
(12) Patent Application Publication
(10) Pub. No.: US 2022/0300957 A1
(43) Pub. Date: Sep. 22, 2022

(54) CONTROL METHOD, DEVICE, AND RECORDING MEDIUM

(71) Applicant: Panasonic Intellectuall Property Corporation of America, Torrance, CA (US)

(72) Inventors: Yuji UNAGAMI, Osaka (JP); Junji MICHIYAMA, Fukuoka (JP); Junichiro SOEDA, Nara (JP); Motoji OHMORI, Osaka (JP); Tetsuji FUCHIKAMI, Osaka (JP); Yuuki HIROSE, Osaka (JP); Naohisa NISHIDA, Osaka (JP); Masahiro TAGUCHI, Osaka (JP)

(21) Appl. No.: 17/835,189

(22) Filed: Jun. 8, 2022

Related U.S. Application Data
(63) Continuation of application No. PCT/JP2020/046398, filed on Dec. 11, 2020.
(60) Provisional application No. 62/950,505, filed on Dec. 19, 2019.

(51) Int. Cl. G06Q 20/38; G06Q 20/40

(52) U.S. Cl. CPC G06Q 20/389; G06Q 20/401; G06Q 20/3825

(57) ABSTRACT

A control method includes: storing, into a distributed ledger, first transaction data that includes a first variable indicating an authorizer, the first variable being set to a predetermined value indicating that the authorizer is undetermined; executing storing processing of storing the predetermined value into a rewritable storage; obtaining second transaction data that includes a change command for changing the first variable to identification information of a third user; storing the second transaction data into the distributed ledger; executing change processing of changing, according to the change command, the first variable stored in the storage; obtaining third transaction data that includes a fulfillment command for executing fulfillment processing of fulfilling a first contract; storing the third transaction data into the distributed ledger; and executing the fulfillment processing according to the fulfillment command when the first variable stored in the storage is determined to be other than the predetermined value.

### CROSS REFERENCE TO RELATED APPLICATIONS

This is a continuation application of PCT International Application No. PCT/JP2020/046398 filed on Dec. 11, 2020, designating the United States of America, which is based on and claims priority of U.S. Provisional Patent Application No. 62/950,505 filed on Dec. 19, 2019. The entire disclosures of the above-identified applications, including the specifications, drawings and claims are incorporated herein by reference in their entirety.

### FIELD

The present disclosure relates to a control method, a device, and a recording medium.

### BACKGROUND

There is a technology for managing information on contracts, using distributed ledgers. Information stored in distributed ledgers is managed so as to be substantially unable to be rewritten.

A technology of using the same operating policy and making the operating timings coincide even in a situation in which a plurality of managers are present in a system in which distributed ledgers are used has been disclosed.

### CITATION LIST

### Patent Literature

PTL 1: WO No. 2019/021792

### SUMMARY

### Technical Problem

The present disclosure provides, for instance, a control method for reducing an increase in power consumption of a computer system that manages contracts.

### Solution to Problem

A control method according to an aspect of the present disclosure is a control method executed by a device out of a plurality of devices each having a distributed ledger in a contract management system that includes the plurality of devices, the control method including: obtaining first transaction data that includes a first variable indicating an authorizer having authority to determine that a first contract made between a first user and a second user is valid, the first variable being set to a predetermined value indicating that the authorizer is undetermined; storing the first transaction data obtained into the distributed ledger; executing storing processing of reading out the predetermined value included as the first variable in the first transaction data stored in the distributed ledger, and storing the predetermined value into a storage included in the device, the storage being rewritable; obtaining second transaction data that includes a change command for changing the first variable to identification information of a third user; storing the second transaction data obtained into the distributed ledger; executing change processing of changing, according to the change command, the first variable stored in the storage, after the second transaction data is stored into the distributed ledger; obtaining third transaction data that includes a fulfillment command for executing fulfillment processing of fulfilling the first contract; storing the third transaction data obtained into the distributed ledger; and executing the fulfillment processing according to the fulfillment command when the first variable stored in the storage is determined to be other than the predetermined value, after the third transaction data is stored into the distributed ledger.

Note that these general and specific aspects may be implemented using a system, a device, an integrated circuit, a computer program, a computer-readable recording medium such as a CD-ROM, or any combination of systems, devices, integrated circuits, computer programs, or recording media.

### Advantageous Effects

The control method according to the present disclosure can reduce an increase in power consumption of a computer system that manages contracts.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an explanatory drawing schematically illustrating examples of flows of contracts in Embodiment 1.

FIG. 2 is a block diagram schematically illustrating a configuration of a contract management system in Embodiment 1.

FIG. 3 is a block diagram illustrating a functional configuration of a ledger server in Embodiment 1.

FIG. 4 is an explanatory drawing illustrating a first example of transaction data in Embodiment 1.

FIG. 5 is an explanatory drawing illustrating a second example of transaction data in Embodiment 1.

FIG. 6 is an explanatory drawing illustrating a third example of transaction data in Embodiment 1.

FIG. 7 is an explanatory drawing illustrating a fourth example of transaction data in Embodiment 1.

FIG. 8 is a first sequence diagram illustrating processing in the contract management system in Embodiment 1.

FIG. 9 is a second sequence diagram illustrating processing in the contract management system in Embodiment

FIG. 10 is an explanatory drawing illustrating a first example of transaction data in Embodiment 2.

FIG. 11 is an explanatory drawing illustrating a second example of transaction data in Embodiment 2.

FIG. 12 is a flowchart illustrating processing performed by a ledger server in Embodiment 2.

FIG. 13 is an explanatory drawing illustrating an example of transaction data in Embodiment 3.

FIG. 14 is a sequence diagram illustrating processing in a contract management system in Embodiment 3.

FIG. 15 is an explanatory drawing illustrating a variation of a supply chain.

FIG. 16 is an explanatory drawing illustrating a data structure of a blockchain.

FIG. 17 is an explanatory drawing illustrating a data structure of transaction data.

### DESCRIPTION OF EMBODIMENTS

(Underlying Knowledge Forming Basis of the Present Disclosure)

The inventors have found that the technology related to contracts mentioned in the “Background” section has problems as below.

There is a technology for managing information on contracts, using distributed ledgers. Information stored in distributed ledgers is managed so as to be substantially unable to be rewritten. In addition, there has been a technology for executing processing related to a contract using distributed ledgers and managing the contract. Such a technology can be implemented with use of a smart contract, for example.

There is a contract that is made and thereafter fulfilled when the contract that has been made is determined to be valid. Such a contract is not fulfilled in an initial state at the time when the contract is made, or in other words, is initially in an invalid state at the time when the contract is made.

When such a contract is managed using distributed ledgers, it is assumed that the content of the contract is stored into the distributed ledgers, and thereafter information indicating whether the contract is determined to be valid is stored into the distributed ledgers. However, information stored in the distributed ledgers is managed so as to be substantially unable to be rewritten as stated above, and thus the content of the contract cannot be changed at the point in time when the contract is determined to be valid.

In view of this, when a contract to be fulfilled if the contract that has been made is determined to be valid is managed, there is a method for managing new content of the contract to which information indicating that the contract is determined to be valid is added, using distributed ledgers after the contract is determined to be valid.

If the new content of the contract is determined and managed using distributed ledgers by a person, processing of presenting information to a person and receiving input of information from a person will be necessary, and power consumption of a computer used for the processing increases, which is a problem. In addition, there is a problem that more computer resources, such as, for example, an output device for presenting information (such as a display device or a loudspeaker) or a device for receiving input of information (such as a touch panel, a keyboard, or a mouse), are necessary for the processing.

Furthermore, there is a problem that a person is involved so that manpower is required. Moreover, a problem may arise that a person accidentally generates and stores incorrect content of a contract into distributed ledgers.

The present disclosure provides, for instance, a control method for reducing an increase in power consumption of a computer system that manages contracts.

A control method according to an aspect of the present disclosure is a control method executed by a device out of a plurality of devices each having a distributed ledger in a contract management system that includes the plurality of devices, the control method including: obtaining first transaction data that includes a first variable indicating an authorizer having authority to determine that a first contract made between a first user and a second user is valid, the first variable being set to a predetermined value indicating that the authorizer is undetermined; storing the first transaction data obtained into the distributed ledger; executing storing processing of reading out the predetermined value included as the first variable in the first transaction data stored in the distributed ledger, and storing the predetermined value into a storage included in the device, the storage being rewritable; obtaining second transaction data that includes a change command for changing the first variable to identification information of a third user; storing the second transaction data obtained into the distributed ledger; executing change processing of changing, according to the change command, the first variable stored in the storage, after the second transaction data is stored into the distributed ledger; obtaining third transaction data that includes a fulfillment command for executing fulfillment processing of fulfilling the first contract; storing the third transaction data obtained into the distributed ledger; and executing the fulfillment processing according to the fulfillment command when the first variable stored in the storage is determined to be other than the predetermined value, after the third transaction data is stored into the distributed ledger.

According to the above aspect, at the point in time when the first contract is made, even if information indicating that the authorizer is undetermined is included, transaction data for the first contract is managed using the distributed ledger, and the authorizer set thereafter is further appropriately managed by changing the information. Then, the first contract is managed so that the fulfillment processing is performed thereon after checking that the authorizer of the first contract is not undetermined. The undetermined information is changed by computer processing in servers, or stated differently, without a person being involved. Thus, an increase in power consumption of a computer can be reduced, and a necessary number of computer resources can be reduced. Furthermore, labor required if a person performs processing can be decreased. Accordingly, the control method can reduce an increase in power consumption of a computer system that manages contracts.

In executing the fulfillment processing, the fulfillment processing may be executed according to the fulfillment command when the first variable stored in the storage is determined to be set to the identification information of the third user as the authorizer, after the third transaction data is stored into the distributed ledger.

According to the above aspect, the first contract is managed so that the fulfillment processing is performed thereon after checking that the variable is set to the identification information of the third user as an authorizer. Accordingly, the control method can reduce an increase in power consumption of a computer system that manages contracts in which three parties are involved.

The first variable may further include a digital signature of the authorizer that is to be given to the first transaction data, and in executing the fulfillment processing, the fulfillment processing may be executed according to the fulfillment command when the digital signature included in the first variable stored in the storage is successfully verified, after the third transaction data is stored into the distributed ledger.

According to the above aspect, the signature of the authorizer for the first transaction data is given, and thus it can be confirmed that the authorizer has certainly referred to the first contract and determined that the first contract is valid. Accordingly, the control method can reduce an increase in power consumption of a computer system that manages contracts, while allowing it to be confirmed that the authorizer determines that the contract is valid.

The first transaction data may include first contract code that includes the first variable and a storing command for storing the first variable into the storage, and the storing processing may be performed by a contract executor included in the device executing the storing command included in the first contract code, in response to the first transaction data being stored into the distributed ledger.

According to the above aspect, processing of storing the first transaction data into the storage is automatically executed by a smart contract in response to the first transaction data being stored into the distributed ledger, or in other words, is executed without a person being involved. Thus, an increase in power consumption of a computer can be further reduced, and a necessary number of computer resources can be further reduced. In addition, labor required if a person performs processing can be further decreased. Accordingly, the control method can further reduce an increase in power consumption of a computer system that manages contracts.

The first transaction data may include first contract code that includes the first variable and a storing command for storing the first variable into the storage. The storing processing may be performed by a contract executor included in the device executing the storing command included in the first contract code, in response to the first transaction data being stored into the distributed ledger. The first contract code may include a signature setting function for assigning the digital signature stored as the first variable in the storage. When fourth transaction data that includes a command for setting the first variable to the digital signature of the authorizer by executing the signature setting function is obtained, the change processing may be performed by the contract executor executing the signature setting function, in response to the fourth transaction data obtained being stored into the distributed ledger.

According to the above aspect, the signature of the authorizer is stored into the storage using the signature setting function provided in advance by being included in the first contract code. Since the signature setting function provided in advance by being included in the first contract code is used, labor required if a person performs processing can be further decreased, an increase in power consumption of a computer can be further reduced, and a necessary number of computer resources can be further reduced.

The second transaction data may include second contract code that includes the change command, and the change processing may be performed by a contract executor included in the device executing the change command, in response to the second transaction data being stored into the distributed ledger. According to the above aspect, the change processing is automatically executed by a smart contract in response to the second transaction data being stored into the distributed ledger, or in other words, is executed without a person being involved. Thus, an increase in power consumption of a computer can be further reduced, and a necessary number of computer resources can be further reduced. In addition, labor required if a person performs processing can be further decreased. Accordingly, the control method can further reduce an increase in power consumption of a computer system that manages contracts. The first transaction data may include a digital signature of the first user and a digital signature of the second user, and in storing the first transaction data into the distributed ledger, the first transaction data may be stored into the distributed ledger when the digital signature of the first user and the digital signature of the second user that are included in the first transaction data are both successfully verified.

According to the above aspect, the first transaction data for the first contract includes digital signatures of the first user and the second user who have made the first contract. Thus, it can be proved by verifying the digital signatures that the first user and the second user have certainly made the first contract. Accordingly, the above control method can further appropriately manage contracts.

The control method may further include: obtaining fifth transaction data that includes a second variable related to a second contract made between the first user and the third user; and storing the fifth transaction data obtained into the distributed ledger. The second transaction data may be provided in response to the fifth transaction data being stored into the distributed ledger.

According to the above aspect, if the third user is determined by the second contract being made after the point in time when the first contract is made, the second transaction data for changing the authorizer is automatically stored into the distributed ledger in response to the fifth transaction data being stored into the distributed ledger, and the authorizer is changed. Thus, labor required if a person performs processing can be further decreased, an increase in power consumption of a computer can be further reduced, and a necessary number of computer resources can be further reduced.

The first contract may include a contract that stipulates that the first user is to purchase material from the second user, and the material purchased is to be delivered to a predetermined delivery destination by a predetermined deadline, the second contract may include a contract that stipulates that the third user is to manufacture a product from the material delivered from the second user, and deliver the product to the first user, the fifth transaction data may include a plurality of second variables each of which is the second variable, and the plurality of second variables may include a variable indicating a purchase price of the product, a variable indicating a deadline for delivering the product, and a variable indicating a delivery destination of the product.

According to the above aspect, even if an authorizer who determines that the material contract is valid is undetermined at the point in time when the material contract is made, a manufacturer identified by the manufacturing contract being made thereafter is changed to be the authorizer, so that the material contract is appropriately managed. Accordingly, the above control method can appropriately manage the material contract made between the first user and the second user, and the authorizer of the material contract.

A device according to an aspect of the present disclosure is a device out of a plurality of devices each having a distributed ledger in a contract management system that includes the plurality of devices, the device including: a processor; a ledger storage that stores therein the distributed ledger; an executor; and a storage that is rewritable. The processor obtains first transaction data that includes a first variable indicating an authorizer having authority to determine that a first contract made between a first user and a second user is valid, and stores the first transaction data obtained into the distributed ledger, the first variable being set to a predetermined value indicating that the authorizer is undetermined. The executor executes storing processing of reading out the predetermined value included as the first variable in the first transaction data stored in the distributed ledger, and storing the predetermined value into the storage that is rewritable. The processor further obtains second transaction data that includes a change command for changing the first variable to identification information of a third user, and stores the second transaction data obtained into the distributed ledger. The executor further executes change processing of changing, according to the change command, the first variable stored in the storage, after the second transaction data is stored into the distributed ledger.

The processor further obtains third transaction data that includes a fulfillment command for executing fulfillment processing of fulfilling the first contract, and stores the third transaction data obtained into the distributed ledger. The executor further executes the fulfillment processing according to the fulfillment command when the first variable stored in the storage is determined to be other than the predetermined value, after the third transaction data is stored into the distributed ledger.

According to the above aspect, advantageous effects similar to those achieved by the above control method can be yielded.

A recording medium according to an aspect of the present disclosure is a non-transitory computer-readable recording medium having recorded thereon a program for causing a computer to execute the control method as described above.

According to the above aspect, advantageous effects similar to those achieved by the above control method can be yielded.

Note that these general and specific aspects may be implemented using a system, a device, an integrated circuit, a computer program, a computer-readable recording medium such as a CD-ROM, or any combination of systems, devices, integrated circuits, computer programs, or recording media. The following specifically describes embodiments with reference to the drawings.

Note that the embodiments described below each show a general or specific example. The numerical values, shapes, materials, elements, the arrangement and connection of the elements, steps, the processing order of the steps, and others indicated in the following embodiments are mere examples, and therefore are not intended to limit the present disclosure. Further, among the elements in the following embodiments, elements not recited in any independent claim defining the most generic concept are described as arbitrary elements.

### Embodiment 1

The present embodiment describes, for instance, a contract management system that reduces an increase in power consumption of a computer system that manages contracts and a control method of the contract management system.

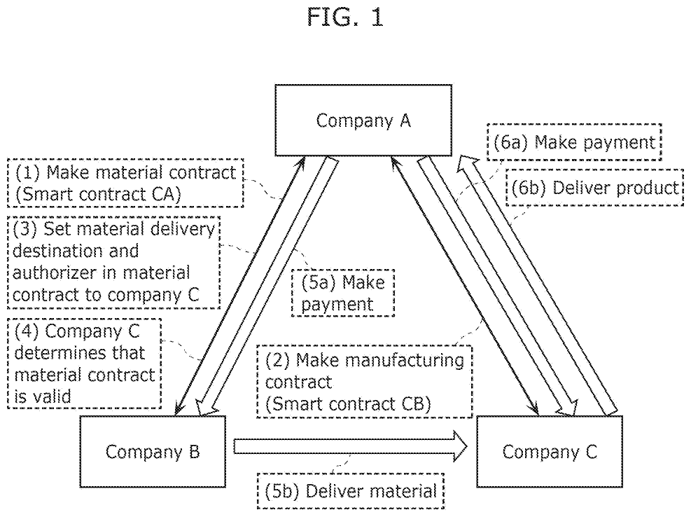

FIG. 1 is an explanatory drawing schematically illustrating examples of flows of contracts in the present embodiment.

Specifically, FIG. 1 schematically illustrates contracts in which three parties, company A, company B, and company C that constitute a supply chain are involved, and delivery of items under the contracts. Company A is also referred to as a first user, company B is also referred to as a second user, and company C is also referred to as a third user.

First, company A and company B make a material contract (corresponding to a first contract) as shown by (1) of FIG. 1. The material contract is a contract that stipulates that company A is to purchase material from company B, and company B is to deliver the material to a delivery destination (also referred to as a material delivery destination). The material contract includes a delivery date of material, a purchase price of the material, and a material delivery destination.

Here, assume a case in which at the point in time when company A and company B make the contract, the purchase price of the material and the delivery date of the material are determined, yet the material delivery destination is undetermined. Furthermore, assume a case in which if the material delivery destination that is to be determined in the future determines that the contract made between company A and company B is valid, the contract is fulfilled. Such a contract is not fulfilled in an initial state at the time when the contract is made, or in other words, is initially in an invalid state at the time when the contract is made. Note that the material delivery destination and the one who has authority to determined that the contract is valid are undetermined at the point in time when company A and company B make a contract, and thus information indicating “undetermined” is set in the material delivery destination in the material contract and the authorizer of the material contract.

After the material contract is made, company A and company C make a manufacturing contract (corresponding to a second contract) as shown by (2) in FIG. 1. The manufacturing contract is a contract that stipulates that company C is to manufacture a product from material, and deliver the manufactured product to company A. The material is delivered from company B. The manufacturing contract includes a delivery date of the product, a purchase price of the product, and a delivery destination of the product (also referred to as a product delivery destination).

Further, (2) in FIG. 1 specifies that the manufacturer of the product is company C, and thus company C is set in the material delivery destination in the material contract that has been made earlier and the authorizer of the material contract ((3) in FIG. 1).

After that, company C that is the authorizer referrers to the content of the material contract, confirms that there is no problem, and determines that the material contract is valid ((4) in FIG. 1).

Since the material contract is determined to be valid, company A pays the purchase price for the material under the material contract to company B ((5a) in FIG. 1), and company B delivers the material to company C ((5b) in FIG. 1), thus fulfilling the material contract.

Furthermore, company A pays the price under the manufacturing contract ((6a) in FIG. 1), and company C delivers the product to company A ((6b) in FIG. 1), thus fulfilling the manufacturing contract.

To execute such processing related to contracts and fulfillment of the contracts using distributed ledgers, it is assumed that one smart contract CA that stipulates content of the material contract and one smart contract CB that stipulates content of the manufacturing contract are used.

In this case, it is assumed that the material delivery destination and the authorizer in smart contract CA are set to “undetermined” when company A and company B make the manufacturing contract, and thereafter are changed or set by smart contract CB executing processing when company A and company C make the manufacturing contract. The material delivery destination and the authorizer are stored in a rewritable storage region in order to allow changing or setting the material delivery destination and the authorizer.

By doing so, the above problems of an increase in power consumption of a computer and necessity of more devices can be avoided, and also a problem caused by a person being involved can be avoided.

The following describes in detail technology for appropriately managing such contracts.

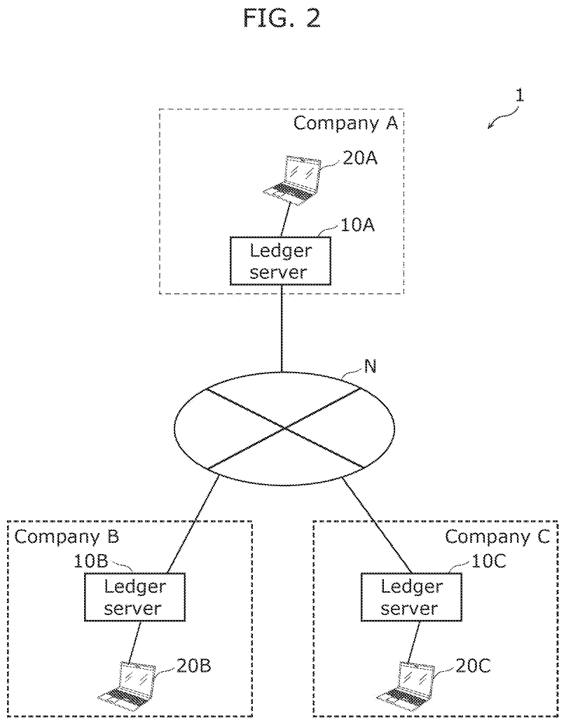

FIG. 2 is a block diagram schematically illustrating a configuration of contract management system 1 in the present embodiment.

As illustrated in FIG. 2, contract management system 1 includes ledger servers 10A, 10B, and 10C, and terminals 20A, 20B, and 20C.

Ledger servers 10A, 10B, and 10C are also referred to as “ledger servers 10A to 10C”, and terminals 20A, 20B and 20C are also referred to as “terminals 20A to 20C”.

Ledger server 10A and terminal 20A belong to company A, ledger server 10B and terminal 20B belong to company B, and ledger server 10C and terminal 20C belong to company C. Here, an example in which contract management system 1 manages contracts in which three parties are involved is shown, but nevertheless the number of parties involved in contracts may be four or more.

The devices included in contract management system 1 are directly or indirectly connected to network N, and can communicate with one another via network N.

Network N may include any communication line or network, and may include, for example, the Internet, a mobile phone carrier network, an access network of an Internet provider, or a public access network.

Ledger server 10A is one of ledger servers 10A to 10C that manage contracts using distributed ledgers in contract management system 1. Ledger server 10A may also be referred to as a device.

Ledger server 10A has a distributed ledger. The distributed ledger that ledger server 10A has stores therein transaction data. The transaction data stored in the distributed ledger includes transaction data that includes contract code (also simply referred to as code) for a smart contract related to a contract. Ledger server 10A includes a rewritable storage region other than a storage region in which the distributed ledger is stored, and stores a variable related to a contract into the rewritable storage region.

Ledger servers 10B and 10C are devices having the same function as ledger server 10A, and operate independently from ledger server 10A.

Terminal 20A is an information terminal that a user belonging to company A uses. Terminal 20A is operated by the user, and is used to generate code for a smart contract and to put the code for the smart contract in ledger servers 10A to 10C, for example. Terminal 20A is, for example, a personal computer, a smartphone, or a tablet terminal.

Terminals 20B and 20C each have the same function as terminal 20A, are information terminals used by a user belonging to company B and a user belonging to company C, respectively, and operate independently from terminal 20A.

Note that company A, company B, and company C may each own one or more terminals.

Note that terminal 20A may further have functions of ledger server 10A. In that case, terminal 20A corresponds to a device that manages a contract using a distributed ledger. Similarly, terminal 20B may further have functions of ledger server 10B. In that case, terminal 20B corresponds to a device that manages a contract using a distributed ledger. Moreover, terminal 20C may further have functions of ledger server 10C. In that case, terminal 20C corresponds to a device that manages a contract using a distributed ledger.

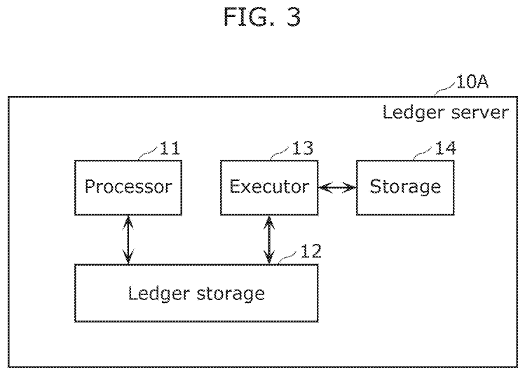

FIG. 3 is a block diagram illustrating a functional configuration of ledger server 10A in the present embodiment.

As illustrated in FIG. 3, ledger server 10A includes processor 11, ledger storage 12, executor 13, and storage 14.

Processor 11 is a functional unit that executes processing related to transaction data. Processor 11 can be acquired by a processing unit (for example, a central processing unit (CPU)) included in ledger server 10A executing a program using a memory.

Processor 11 executes processing of obtaining transaction data, and storing the obtained transaction data into the distributed ledger. Further, processor 11 executes processing of generating transaction data, generating a digital signature (also simply referred to as a signature) for the generated transaction data, and giving the generated signature to the transaction data.

In storing new transaction data into the distributed ledger, processor 11 stores the new transaction data into ledger storage 12 in the form according to the type of the distributed ledger.

Processor 11 transmits communication data to and receives communication data from ledger storage 12 that is included in another ledger server out of ledger servers 10A to 10C, and causes ledger storage 12 included in the other ledger server to also store the transaction data. For example, when the distributed ledger is a blockchain, processor 11 generates a block that includes new transaction data, and stores the block into ledger storage 12 after ledger servers 10A to 10C reach agreement on the generated block by consensus algorithm. Specifically, processor 11 obtains first transaction data, and stores the obtained first transaction data into the distributed ledger. The first transaction data includes a variable (also referred to as a first variable) indicating an authorizer having authority to determine that the material contract (the first contract) made between company A and company B is valid, and set to a predetermined value indicating that the authorizer is undetermined. For the predetermined value, a numerical value (zero, for example) that is actually not used to indicate the material delivery destination or a predetermined reserved value, which fall within a range of numerical values that can be assigned to the second variable, can be used.

Further, processor 11 obtains second transaction data, and stores the obtained second transaction data into the distributed ledger. The second transaction data includes a change order for changing the first variable to identification information of company C. Note that the second transaction data may be second transaction data provided in response to fifth transaction data that includes a variable (also referred to as a second variable) related to the second contract made between company A and company C being stored into the distributed ledger.

Further, processor 11 obtains third transaction data, and stores the obtained third transaction data into the distributed ledger. The third transaction data includes a fulfillment command for executing fulfillment processing of fulfilling the material contract.

Ledger storage 12 stores therein the distributed ledger. The distributed ledger stored in ledger storage 12 stores one or more transaction data items, and is managed using features of hash values, for instance, so that manipulation is difficult (this will be described later). Ledger storage 12 stores transaction data provided by processor 11 into the distributed ledger. The distributed ledger stores past to current transaction data items. Such transaction data items are managed so as not to be manipulated, based on a feature that information recorded in a distributed ledger is difficult to be manipulated.

Note that the distributed ledger is a blockchain, for example, and such a case is described as an example. Yet it is possible to adopt a distributed ledger according to another technique (such as IOTA or Hashgraph, for example). Note that the distributed ledger may be or may not be a ledger for which consensus algorithm (for example, Practical Byzantine Fault Tolerance (PBFT), Proof of Work (PoW), or Proof of Stake (PoS)) is executed when new data is stored. An example of distributed ledger technology in which consensus algorithm is not executed is Hyperledger Fabric.

Executor 13 is a functional unit that executes processing with reference to transaction data stored in the distributed ledger stored in ledger storage 12. Executor 13 can be acquired by the processing unit (a CPU, for example) included in ledger server 10A executing a program using memory. Here, the case in which executor 13 is a contract executor that executes processing in accordance with smart contract code included in transaction data stored in the distributed ledger is to be described as an example.

Specifically, after the first transaction data is stored into the distributed ledger, executor 13 executes storing processing of reading out a predetermined value included as the first variable in the first transaction data stored in the distributed ledger, and storing the predetermined value into storage 14.

The storing processing is performed by executor 13 executing the first contract code, in response to the first transaction data being stored into the distributed ledger, for example. Note that when fourth transaction data that includes a command for executing a signature setting function is included, change processing may be performed by executor 13 executing the signature setting function, in response to the fourth transaction data obtained being stored into the distributed ledger. In this case, the first contract code includes the signature setting function for setting a digital signature stored as the first variable in storage 14.

Further, after the second transaction data is stored into the distributed ledger, executor 13 executes change processing of changing the first variable stored in storage 14, according to the change command.

The change processing is performed by executor 13 executing the change command, in response to the second transaction data being stored into the distributed ledger, for example. Here, the second transaction data includes second contract code that includes the change command.

Further, after the third transaction data is stored into the distributed ledger, executor 13 executes fulfillment processing, according to the fulfillment command when the first variable stored in storage 14 is determined to be other than the predetermined value after the third transaction data is stored into the distributed ledger.

In executing the fulfillment processing, the fulfillment processing may be executed according to the fulfillment command when the first variable stored in storage 14 is determined to be set to the identification information of the third user as the authorizer, after the third transaction data is stored into the distributed ledger.

At this time, the fulfillment processing may be executed according to the fulfillment command when the digital signature included in the first variable stored in storage 14 is successfully verified, after the third transaction data is stored into the distributed ledger. Here, the first variable is assumed to further include a digital signature of an authorizer that is to be given to the first transaction data.

Storage 14 is a storage device that includes a storage region storing variables. Variables indicate information on contracts, and specifically include the first variable and the second variable. The variables stored in storage 14 are set and read out by executor 13. Storage 14 is acquired using by a rewritable storage device, examples of which include memory such as random access memory (RAM), a hard disk drive (HDD), and a solid state drive (SSD).

Note that multi-signature (multisig) technology for giving a plurality of signatures may be applied to the first transaction data, and this case will be described as an example, but a single digital signature may be given to the first transaction data.

Specifically, the first transaction data may include digital signatures of company A and company B that are the contractors of the material contract. In that case, in storing the first transaction data into the distributed ledger, processor 11 stores the first transaction data into the distributed ledger when the digital signatures of company A and company B included in the first transaction data are both successfully verified. Note that the first contract and the second contract can be expressed as below. Specifically, the first contract includes a contract that stipulates that the first user is to purchase material from the second user, and deliver the material purchased to a predetermined delivery destination by a predetermined deadline. The second contract includes a contract that stipulates that the third user is to manufacture a product from the material delivered from the second user, and deliver the product to the first user. In this case, the plurality of second variables include a variable indicating a purchase price of the product, a variable indicating a deadline for delivering the product, and a variable indicating a delivery destination of the product.

The following describes transaction data and code for a smart contract.

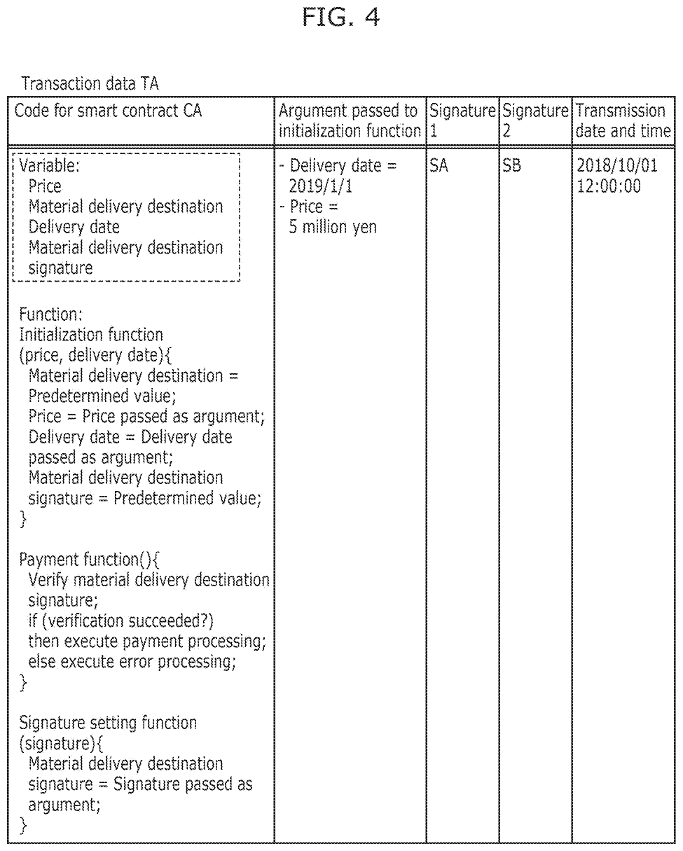

FIG. 4 is an explanatory drawing illustrating transaction data TA that is a first example of transaction data in the present embodiment. Transaction data TA corresponds to first transaction data. Transaction data TA is generated by ledger server 10A, for example.

As illustrated in FIG. 4, transaction data TA includes “Code for smart contract CA”, “Argument passed to initialization function”, “Signature 1”, “Signature 2”, and “Transmission date and time”.

“Code for smart contract CA” includes a variable portion indicating variables used by smart contract CA and stored in storage 14. The variable portion is shown by the broken line frame in FIG. 4. The same expression is also used in the following. The variables used by smart contract CA include a price, a material delivery destination, a delivery date, and a material delivery destination signature. The price indicates the amount of money company A pays in the material contract. The material delivery destination indicates the delivery destination of the material manufactured by company B under the material contract. The delivery date indicates the deadline by which company B is to deliver the material to the material delivery destination. The material delivery destination signature indicates a signature that the material delivery destination is to give to transaction data TA.

Further, “Code for smart contract CA” includes an initialization function, a payment function, and a signature setting function. The initialization function is a special function that is executed by executor 13 when the transaction data is stored into a distributed ledger. The initialization function is a special function that is executed by executor 13 when the transaction data is stored into a distributed ledger. The same applies hereinafter.

The initialization function receives a price and a delivery date as arguments. Further, if the initialization function is executed, the initialization function assigns values to the variable indicating a material delivery destination, the variable indicating a price, and the variable indicating a delivery date, which are stored in storage 14. Specifically, if the initialization function is executed, the initialization function sets the variable indicating a material delivery destination and a variable indicating a material delivery destination signature to the predetermined values, sets the variable indicating a price to the price received as an argument, and the variable indicating a delivery date to the delivery date received as an argument.

Note that equivalent advantageous effects can be achieved also in the case in which the function shown as the initialization function in FIG. 4 is a general function (or in other words, not the initialization function), and the general function is executed using the transaction data. The same applies to an initialization function included in code for another smart contract.

The payment function is a function for executing processing of paying the price under the material contract from company A to company B that is a contractor of the material contract, in order to fulfill the material contract. When the payment function is executed, verification processing of verifying the material delivery destination signature is executed, and if the verification has succeeded, payment processing is executed. If the verification fails, error processing may be executed.

If the signature setting function is executed, the signature setting function sets the material delivery destination signature stored in storage 14.

The signature setting function receives a signature as an argument. If the signature setting function is executed, the signature setting function assigns a value to the variable indicating a material delivery destination signature stored in storage 14. Specifically, if the signature setting function is executed, the signature setting function sets the variable indicating a material delivery destination signature to the signature received as an argument.

“Argument passed to initialization function” is an argument that is passed to the initialization function in smart contract CA, and includes the delivery date (Jan. 1, 2019) and the price (5 million yen). Information items indicated as the arguments are passed to the initialization function.

“Signature 1” is the first one of two digital signatures given to transaction data TA. Signature 1 includes signature SA of company A.

“Signature 2” is the second one of the two digital signatures given to transaction data TA. Signature 2 includes signature SB of company B.

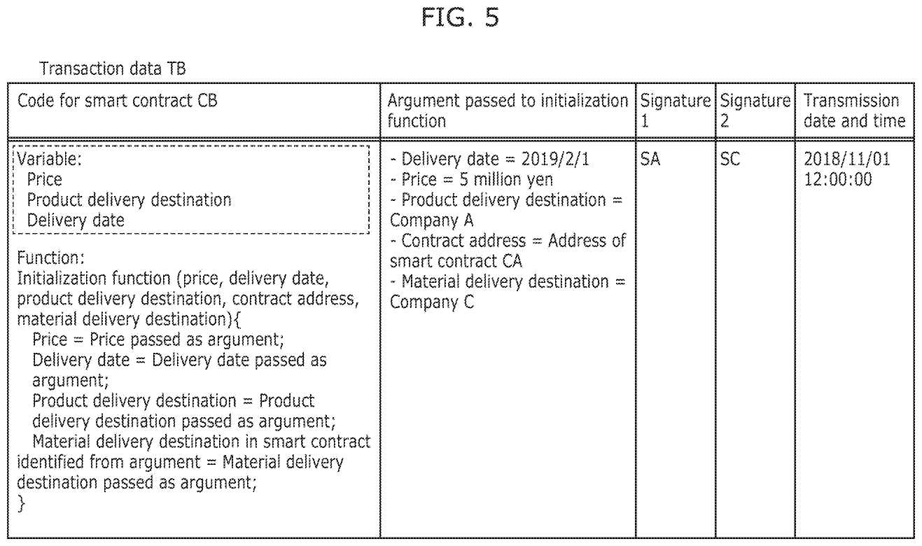

“Transmission date and time” indicates the date and time at which transaction data TA is transmitted. “2018/10/01 12:00:00” is stored in “Transmission date and time”. When transaction data TA shown in FIG. 4 is stored into the distributed ledger, by the initialization function being executed, the variables indicating the price and the delivery date in storage 14 are set to the price and the delivery date, respectively, passed to the initialization function as arguments. FIG. 5 is an explanatory drawing illustrating transaction data TB that is a second example of transaction data in the present embodiment. Transaction data TB is generated by ledger server 10A, for example.

As illustrated in FIG. 5, transaction data TB includes “Code for smart contract CB”, “Argument passed to initialization function”, “Signature 1”, “Signature 2”, and “Transmission date and time”.

“Code for smart contract CB” includes a variable portion and an initialization function. The variables used by smart contract CB include a price, a product delivery destination, and a delivery date. The price indicates the amount of money company A pays in the manufacturing contract. The product delivery destination indicates the delivery destination of a product manufactured by company C under the manufacturing contract. The delivery date indicates the deadline by which company C is to deliver the product to the product delivery destination.

The initialization function receives a price, a delivery date, a product delivery destination, a contract address, and a material delivery destination, as arguments. Further, if the initialization function is executed, the initialization function assigns values to the variable indicating a price, the variable indicating a delivery date, the variable indicating a product delivery destination, and the variable indicating a material delivery destination, which are stored in storage 14.

Specifically, if the initialization function is executed, the initialization function sets the variable indicating a price to the price received as an argument, sets the variable indicating a delivery date to the delivery date received as an argument, and sets the variable indicating a product delivery destination to the product destination received as an argument. Further, if the initialization function is executed, the initialization function sets the variable indicating a material delivery destination in the smart contract that is identified from the argument to the material delivery destination received as an argument.

“Argument passed to initialization function” is an argument passed to the initialization function in smart contract CB, and includes the delivery date (Feb. 1, 2019), the price (5 million yen), the product delivery destination (identification information of company A), the contract address (the address of smart contract CA), and the material delivery destination (identification information of company C). Information items indicated as the arguments are passed to the initialization function. Note that the identification information of company A set in the product delivery destination that is a variable may also be simply referred to as company A. The same also applies to company B and company C. The same also applies hereinafter.

“Signature 1” is the first one of two digital signatures given to transaction data TB. Signature 1 includes signature SA of company A.

“Signature 2” is the second one of the two digital signatures given to transaction data TB. Signature 2 includes signature SC of company C.

“Transmission date and time” indicates the date and time at which transaction data TB is transmitted. “2018/11/01 12:00:00” is stored in “Transmission date and time”.

When transaction data TB shown in FIG. 5 is stored into a distributed ledger, by the initialization function being executed, the variables indicating a delivery date, a price, and a product delivery destination in storage 14 are set to the delivery date, the price, and the product delivery destination, respectively, passed to the initialization function as arguments. The material delivery destination in smart contract CA is changed to company C, based on the contract address and the material delivery destination passed to the initialization function as arguments.

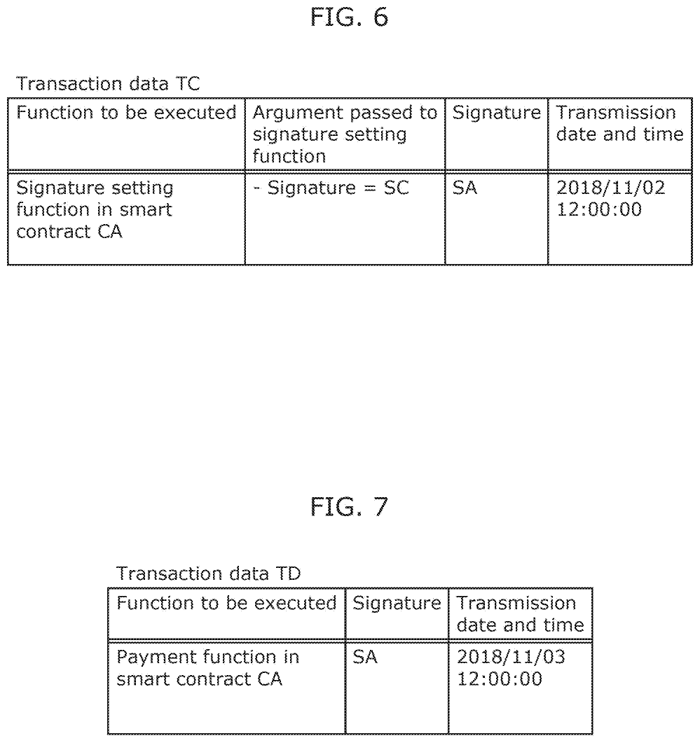

FIG. 6 is an explanatory drawing illustrating transaction data TC that is a third example of transaction data in the present embodiment. Transaction data TC is for executing the signature setting function in smart contract CA. Storing transaction data TC into a distributed ledger corresponds to transmitting a command for executing the signature setting function in smart contract CA. Transaction data TC corresponds to second transaction data.

As illustrated in FIG. 6, transaction data TC includes “Function to be executed”, “Argument passed to signature setting function”, “Signature”, and “Transmission date and time”.

“Function to be executed” indicates a function that is executed by the smart contract being stored into a distributed ledger. In FIG. 6, the signature setting function in smart contract CA is set as a function to be executed.

“Argument passed to signature setting function” indicates an argument passed to the signature setting function that is executed by smart contract CA. The signature of the material delivery destination (that is, the signature of company C) is set in “Argument passed to signature setting function”.

“Signature” is a digital signature given to transaction data TC. “Signature” includes signature SA of company A.

“Transmission date and time” indicates the date and time at which transaction data TC is transmitted. “2018/11/02 12:00:00” is stored in “Transmission date and time”.

By transaction data TC illustrated in FIG. 6 being stored into a distributed ledger, the signature that is an argument is set to the signature of company C, and the signature setting function in smart contract CA is executed. As a result, the material delivery destination in smart contract CA is changed to the signature of company C.

FIG. 7 is an explanatory drawing illustrating transaction data TD that is a fourth example of transaction data in the present embodiment. Transaction data TD is a function for executing the payment function in smart contract CA. Storing transaction data TD into a distributed ledger corresponds to transmitting a command for executing the payment function in smart contract CA. Transaction data TD corresponds to third transaction data.

As illustrated in FIG. 7, transaction data TD includes “Function to be executed”, “Signature”, and “Transmission date and time”.

“Function to be executed” indicates a function that is executed by the smart contract being stored into a distributed ledger. The payment function in smart contract CA is set in “Function to be executed”.

“Signature” is a digital signature given to transaction data TD. “Signature” includes signature SA of company A.

“Transmission date and time” indicates the date and time at which transaction data TD is transmitted. “2018/11/03 12:00:00” is stored in “Transmission date and time”.

The payment function in smart contract CA is executed in response to transaction data TD illustrated in FIG. 7 being stored into a distributed ledger, and as a result, payment processing of company A paying the price under the material contract to company C is executed.

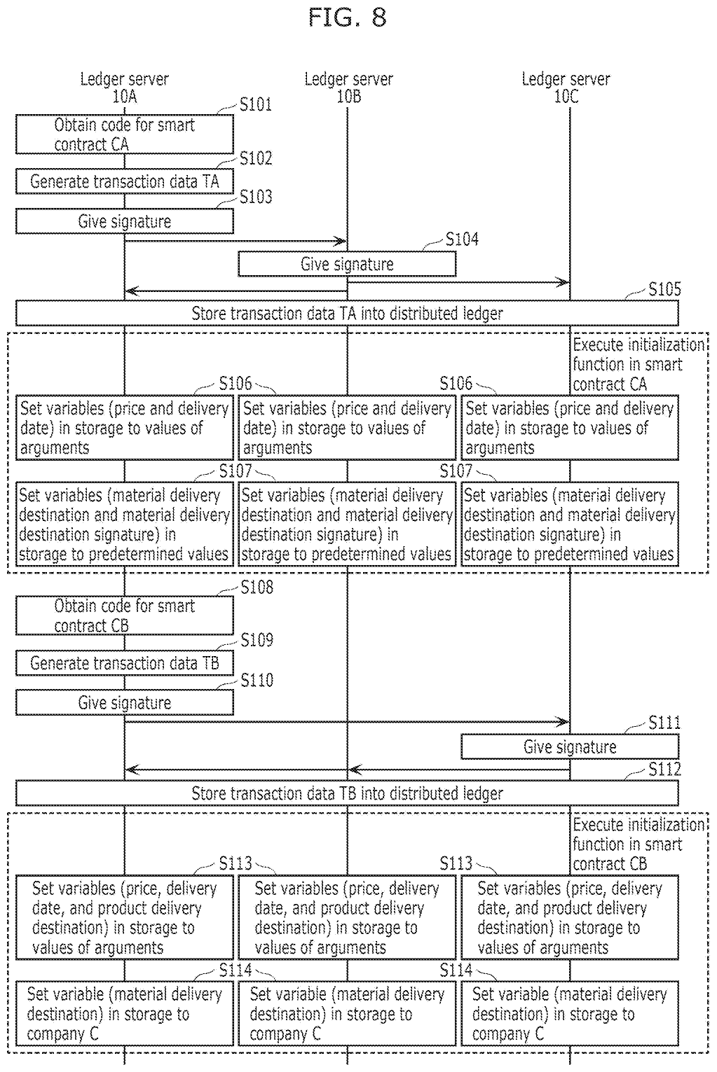

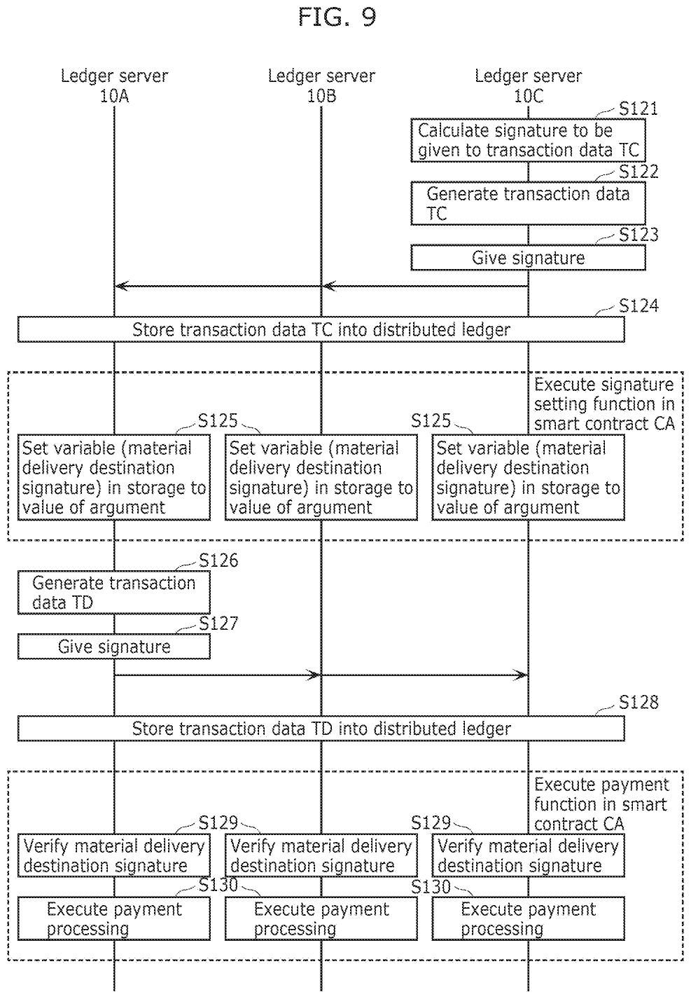

FIG. 8 and FIG. 9 are sequence diagrams each illustrating processing in contract management system 1 in the present embodiment. FIG. 8 and FIG. 9 each illustrate a series of processes related to making a material contract, making a manufacturing contract, and setting an authorizer.

In step S101 in FIG. 8, processor 11 of ledger server 10A obtains code for smart contract CA. The code for smart contract CA may be obtained by ledger server 10A generating the code or by ledger server 10A receiving the code transmitted from terminal 20A in response to an operation made by a person in charge of company A.

In step S102, processor 11 of ledger server 10A generates transaction data TA. Transaction data TA generated includes the code for smart contract CA obtained in step S101 (see FIG. 4).

In step S103, processor 11 of ledger server 10A generates a signature for transaction data TA generated in step S102, gives the signature to transaction data TA, and transmits transaction data TA having the signature to ledger server 10B.

In step S104, processor 11 of ledger server 10B receives transaction data TA transmitted in step S103, generates a signature for transaction data TA received, gives the signature to transaction data TA, and transmits transaction data TA having the signatures to each of ledger servers 10A and 10C. Accordingly, all ledger servers 10A to 10C are in a state of having transaction data TA to which the signatures of ledger servers 10A and 10B are given.

In step S105, each of ledger servers 10A to 10C stores (transmitted) transaction data TA to which the signature is additionally given in step S104, into the distributed ledger. In storing transaction data TA into the distributed ledgers, transaction data TA may be stored into the distributed ledgers under a condition that ledger servers 10A to 10C reach agreement based on consensus algorithm.

Each of processors 11 of ledger servers 10A to 10C executes the initialization function in smart contract CA in response to transaction data TA being stored into the distributed ledger in step S105, to perform step S106 and step S107 as below.

In step S106, processors 11 of ledger servers 10A to 10C each set the variable indicating a price and the variable indicating a delivery date, which are stored in storage 14, to the price and the delivery date passed to the initialization function as arguments in transaction data TA.

In step S107, processors 11 of ledger servers 10A to 10C each set the variable indicating a material delivery destination and the variable indicating a material delivery destination signature, which are stored in storage 14, to the predetermined values. The predetermined values indicate that the material delivery destination and the material delivery destination signature are undetermined.

In step S108, processor 11 of ledger server 10A obtains code for smart contract CB. The code for smart contract CB may be obtained by ledger server 10A generating the code or by ledger server 10A receiving the code transmitted from terminal 20A in response to an operation made by a person in charge of company A.

In step S109, processor 11 of ledger server 10A generates transaction data TB. Transaction data TB generated includes the code for smart contract CB obtained in step S108 (see FIG. 5).

In step S110, processor 11 of ledger server 10A generates a signature for transaction data TB generated in step S109, gives the signature to transaction data TB, and transmits transaction data TB having the signature to ledger server 10C.

In step S111, processor 11 of ledger server 10C receives transaction data TB transmitted in step S110, generates a signature for transaction data TB received, gives the signature to transaction data TB, and transmits transaction data TB having the signatures to each of ledger servers 10A and 10B. Accordingly, all ledger servers 10A to 10C are in a state of having transaction data TB to which the signatures of ledger servers 10A and 10C are given.

In step S112, each of ledger servers 10A to 10C stores (transmitted) transaction data TB to which the signature is additionally given in step S111, into the distributed ledger. In storing transaction data TB into the distributed ledgers, transaction data TB may be stored into the distributed ledgers under a condition that ledger servers 10A to 10C reach agreement based on consensus algorithm.

Each of processors 11 of ledger servers 10A to 10C executes the initialization function in smart contract CB in response to transaction data TB being stored into the distributed ledger in step S112, to perform step S113 and step S114 as below.

In step S113, processors 11 of ledger servers 10A to 10C each set the variable indicating a price, the variable indicating a delivery date, and the variable indicating a product delivery destination, which are stored in storage 14, to the price, the delivery date, and the product delivery destination passed to the initialization function as arguments in transaction data TB.

In step S114, processors 11 of ledger servers 10A to 10C each set the variable indicating a material delivery destination in smart contract CA, which is stored in storage 14, to identification information of company C.

Now referring to FIG. 9, processor 11 of ledger server 10C calculates a signature to be given to transaction data TC in step S121.

In step S122, processor 11 of ledger server 10C generates transaction data TC. Generated transaction data TC includes the signature calculated in step S121.

In step S123, processor 11 of ledger server 10C gives the signature for transaction data TC generated in step S122 to transaction data TC, and transmits transaction data TC having the signature to ledger servers 10A and 10B.

In step S124, each of ledger servers 10A to 10C stores (transmitted) transaction data TC to which the signature is given in step S123, into the distributed ledger.

Each of processors 11 of ledger servers 10A to 10C executes the signature setting function in smart contract CA in response to transaction data TC being stored into the distributed ledger in step S124, to perform step S125 as below.

In step S125, each of processors 11 of ledger servers 10A to 10C sets the material delivery destination signature stored in storage 14 to the signature passed as an argument to the signature setting function in transaction data TC.

In step S126, processor 11 of ledger server 10A generates transaction data TD.

In step S127, processor 11 of ledger server 10A generates a signature for transaction data TD generated in step S126, gives the signature to transaction data TD, and transmits transaction data TD having the signature to ledger servers 10B and 10C.

In step S128, each of ledger servers 10A to 10C stores (transmitted) transaction data TD to which the signature is given in step S127, into the distributed ledger.

Each of processors 11 of ledger servers 10A to 10C executes the payment function in smart contract CA in response to transaction data TD being stored into the distributed ledger in step S128, to perform steps S129 and S130 as below.

In step S129, each of processors 11 of ledger servers 10A to 10C executes verification processing of verifying the material delivery destination signature stored in storage 14.

In step S130, each of processors 11 of ledger servers 10A to 10C executes payment processing if verification processing of verifying the material delivery destination signature in step S129 is determined to have succeeded.

Note that, here, the case has been described in which ledger server 10A (that is, company A) generates code for smart contracts and transaction data related to the material contract and the manufacturing contract, yet company B and company C may instead generate such code and data related to the material and manufacturing contracts, respectively.

By performing the above series of processes, contract management system 1 can appropriately manage a contract that is made between company A and company B and for which an authorizer who determines that the contract is valid is set.

Accordingly, contract management system 1 can reduce an increase in power consumption of a computer system that manages contracts, while appropriately managing contracts in which company A, company B, and company C are involved.

### Embodiment 2

The present embodiment describes, for instance, a contract management system that reduces an increase in power consumption of a computer system that manages contracts and a control method of the contract management system according to aspects different from Embodiment 1.

The contract management system in the present embodiment further appropriately manages a contract when an authorizer who determines that a material contract is valid is specified. Here, the authorizer who determines that the material contract is valid is referred to as an owner, yet how the authorizer is referred to is not limited thereto.

The flows of contracts in the present embodiment are the same as those in Embodiment 1 (see FIG. 1). In addition, the configuration of ledger servers 10A to 10C is the same as that of Embodiment 1 (see FIG. 3).

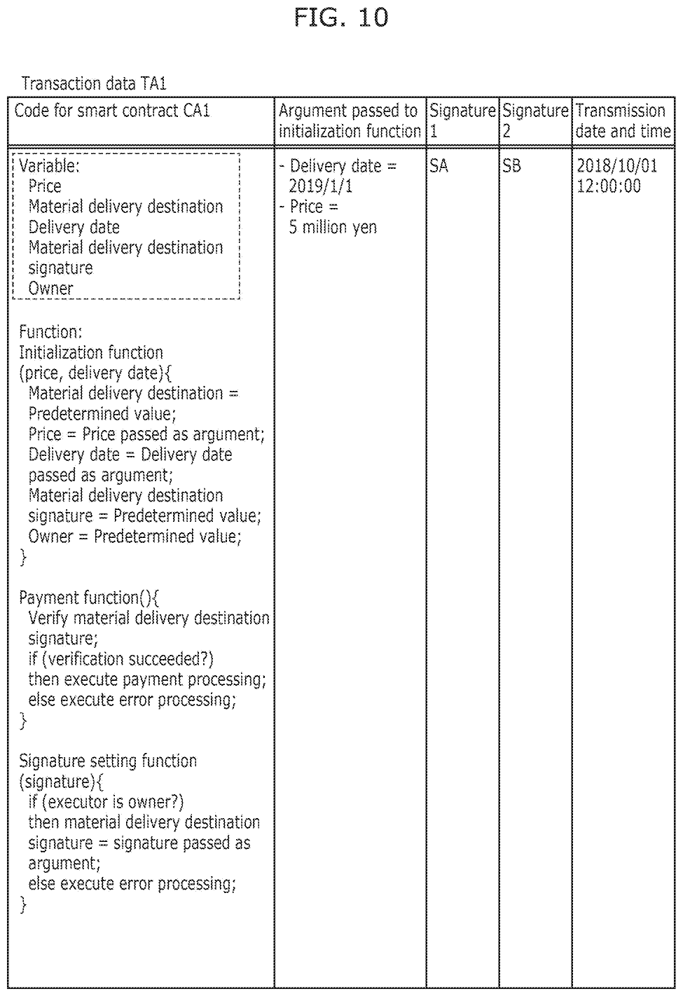

FIG. 10 is an explanatory drawing illustrating transaction data TA1 that is a first example of transaction data in the present embodiment. Transaction data TA1 corresponds to first transaction data. Transaction data TA1 is generated by ledger server 10A, for example.

As illustrated in FIG. 10, transaction data TA1 includes “Code for smart contract CA1”, “Argument passed to initialization function”, “Signature 1”, “Signature 2”, and “Transmission date and time”.

“Code for smart contract CA1” includes a variable portion, an initialization function, a payment function, and a signature setting function.

The variable portion indicates variables used by smart contract CA1 and stored in storage 14. The variables used by smart contract CA1 include a price, a material delivery destination, a delivery date, a material delivery destination signature, and an owner. The price, the material delivery destination, the delivery date, and the material delivery destination signature are the same as those in smart contract CA in Embodiment 1 (see FIG. 4). The owner indicates the owner of the material contract.

The initialization function and the payment function are the same as those in smart contract CA in Embodiment 1 (see FIG. 4).

The signature setting function receives a signature as an argument. If the signature setting function is executed, the signature setting function determines whether the one who has executed the signature setting function (also referred to as an executor) is an owner, and when the executor is determined to be an owner, sets the material delivery destination signature stored in storage 14 to the signature received as an argument. Note that if the executor is determined not to be an owner, predetermined error processing may be performed. The error processing includes processing of displaying an error message indicating that the executor is not an owner on the display screens of terminals 20A to 20C and/or processing of outputting the error message using voice.

“Argument passed to initialization function”, “Signature 1”, “Signature 2”, and “Transmission date and time” are the same as those in smart contract CA in Embodiment 1 (see FIG. 4).

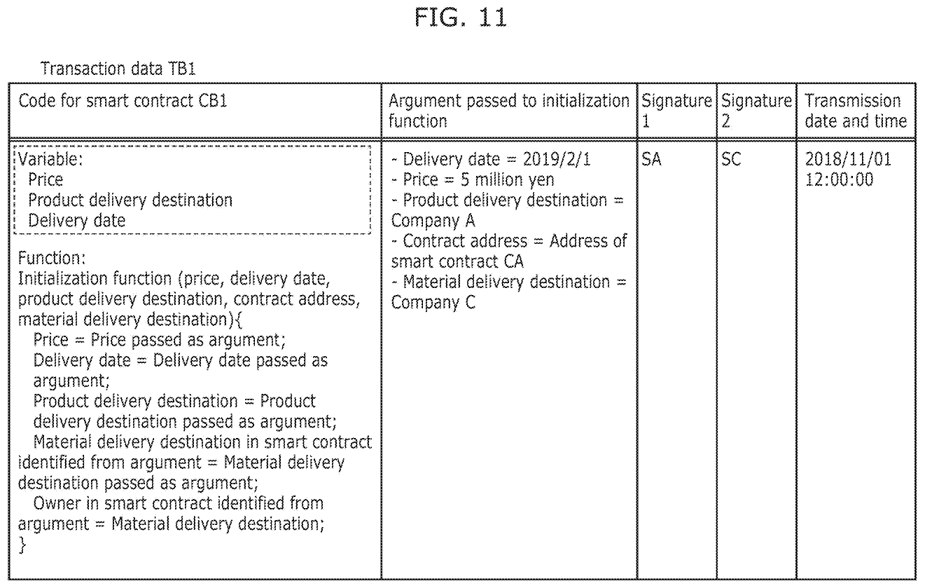

FIG. 11 is an explanatory drawing illustrating transaction data TB1 that is a second example of transaction data in the present embodiment. Transaction data TB1 is generated by ledger server 10A, for example.

As illustrated in FIG. 11, transaction data TB1 includes “Code for smart contract CB1”, “Argument passed to initialization function”, “Signature 1”, “Signature 2”, and “Transmission date and time”.

“Code for smart contract CB1” includes a variable portion and an initialization function. The variables used by smart contract CB1 are the same as those in smart contract CB in Embodiment 1.

The initialization function receives a price, a delivery date, a product delivery destination, a contract address, and a material delivery destination, as arguments. Further, if the initialization function is executed, the initialization function assigns values to the variable indicating a price, the variable indicating a delivery date, the variable indicating a product delivery destination, the variable indicating a material delivery destination, and the variable indicating an owner, which are stored in storage 14. Specifically, if the initialization function is executed, the initialization function sets the variable indicating a price to the price received as an argument, sets the variable indicating a delivery date to the delivery date received as an argument, and sets the variable indicating a product delivery destination to the product delivery destination received as an argument. Further, if the initialization function is executed, the initialization function sets the variable indicating a material delivery destination in the smart contract identified from the argument to the material delivery destination received as an argument, and sets the variable indicating an owner in the smart contract identified from the argument to the material delivery destination received as an argument.

“Argument passed to initialization function”, “Signature 1”, “Signature 2”, and “Transmission date and time” are the same as those in smart contract CB in Embodiment 1 (see FIG. 5).

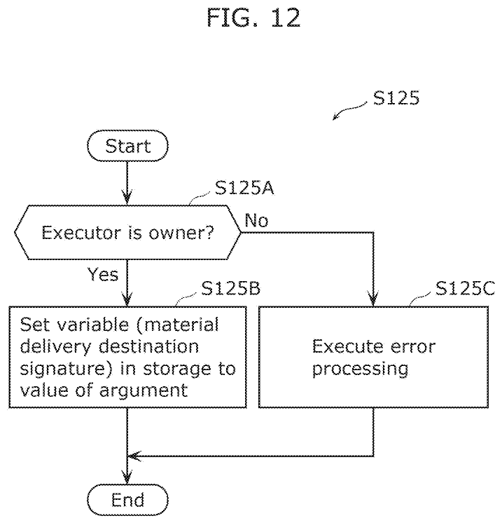

FIG. 12 is a flowchart illustrating processing performed by the ledger servers in the present embodiment. The flowchart illustrated in FIG. 12 indicates processing executed as the processing of step S125 in FIG. 9 in Embodiment 1, and thus illustrates a variation of the processing of step S125. Note that similarly to the case in FIG. 9, step S125 is performed by each of processors 11 of ledger servers 10A to 10C executing the signature setting function in smart contract CA1 in response to transaction data TC being stored into the distributed ledger in step S124

As illustrated in FIG. 12, in step S125A, each of processors 11 of ledger servers 10A to 10C determines whether the executor of the signature setting function is an owner. The executor of the signature setting function is the transmitter of a command for executing the signature setting function, that is, the transmitter of transaction data TC (see FIG. 6), and thus can be identified from the transmitter of a communication packet that includes transaction data TC or the signature in transaction data TC. If the executor is determined to be an owner (Yes in step S125A), the processing proceeds to step S125B, otherwise (No in step S125A), the processing proceeds to step S125C.

In step S125B, each of processors 11 of ledger servers 10A to 10C sets the material delivery destination signature stored in storage 14 to the signature passed as an argument to the signature setting function in transaction data TC.

In step S125C, each of processors 11 of ledger servers 10A to 10C executes error processing. Note that step S125C may not be performed.

By performing the processing illustrated in FIG. 12, the one who can set the material delivery destination signature by executing the signature setting function can be limited to an owner who is an authorizer determined as the one who determines that the material contract is valid.

### Embodiment 3

The present embodiment describes, for instance, a contract management system that reduces an increase in power consumption of a computer system that manages contracts and a control method of the contract management system according to aspects different from Embodiment 1 and Embodiment 2.

The contract management system in the present embodiment contributes to reducing the number of times transaction data is transmitted and received, by storing, from the beginning, the signature of an owner who is an authorizer who determines that a material contract is valid in transaction data corresponding to the manufacturing contract.

In the present embodiment, similarly to Embodiment 1, transition data TA that includes smart contract CA corresponding to the material contract is used (see FIG. 4). Note that the signature setting function is not used, and thus may not be included in smart contract CA.

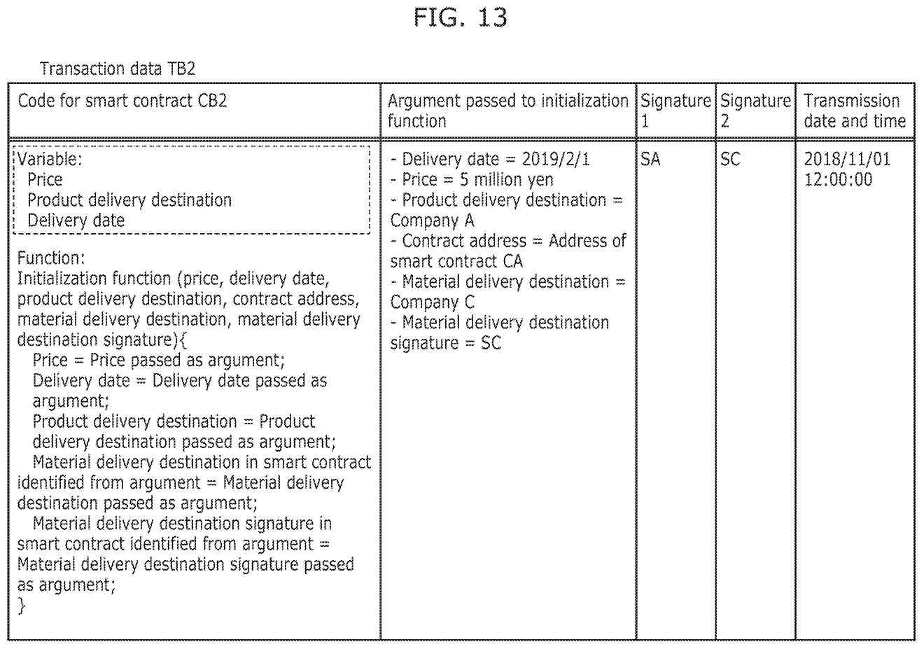

FIG. 13 is an explanatory drawing illustrating transaction data TB2 that is an example of transaction data in the present embodiment. Transaction data TB2 corresponds to second transaction data. Transaction data TB2 is generated by ledger server 10A, for example.

As illustrated in FIG. 13, transaction data TB2 includes “Code for smart contract CB2”, “Argument passed to initialization function”, “Signature 1”, “Signature 2”, and “Transmission date and time”.

“Code for smart contract CB2” includes a variable portion and an initialization function. The variables used by smart contract CB2 are the same as those in smart contract CB in Embodiment 1.

The initialization function receives a price, a delivery date, a product delivery destination, a contract address, a material delivery destination, and the material delivery destination signature as arguments. Further, if the initialization function is executed, the initialization function assigns values to the variable indicating a price, the variable indicating a delivery date, the variable indicating a product delivery destination, the variable indicating a material delivery destination, and the variable indicating a material delivery destination signature, which are stored in storage 14. Specifically, if the initialization function is executed, the initialization function sets the variable indicating a price to the price received as an argument, sets the variable indicating a delivery date to the delivery date received as an argument, and sets the variable indicating a product delivery destination to the product delivery destination received as an argument. Further, if the initialization function is executed, the initialization function sets the variable indicating a material delivery destination in the smart contract identified from the argument to the material delivery destination received as an argument, and sets the variable indicating a material delivery destination signature in the smart contract identified from the argument to the material delivery destination signature received as an argument.

“Argument passed to initialization function” is an argument passed to the initialization function in smart contract CB2, and includes the delivery date (Feb. 1, 2019), the price (5 million yen), the product delivery destination (identification information of company A), the contract address (the address of smart contract CA), the material delivery destination (identification information of company C), and the material delivery destination signature (signature SC of company C).

“Signature 1”, “Signature 2”, and “Transmission date and time” are the same as those in smart contract CB in Embodiment 1 (see FIG. 5).

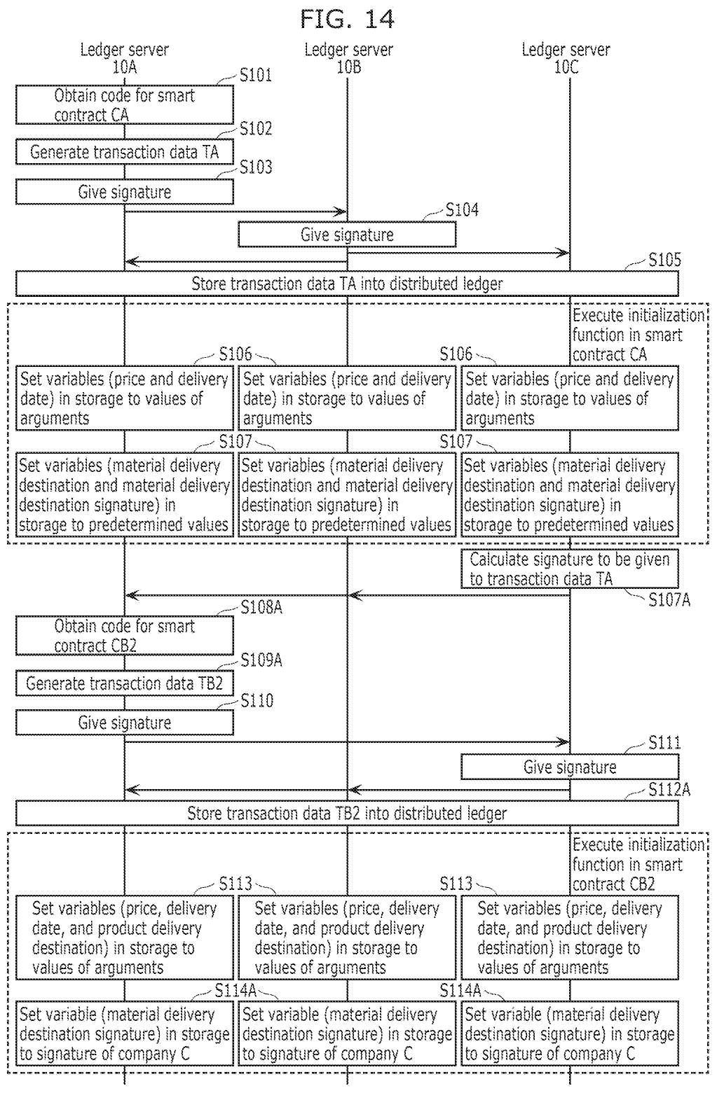

FIG. 14 is a sequence diagram illustrating processing in the contract management system in the present embodiment. FIG. 14 illustrates a series of processes related to making a material contract, generating a signature by an authorizer, and making a manufacturing contract.

Processing from step S101 to step S107 illustrated in FIG. 14 is the same as that in FIG. 8.

In step S107A, processor 11 of ledger server 10C calculates a signature to be given to transaction data TA received in step S104, and transmits the calculated signature to ledger server 10A.

In step S108A, processor 11 of ledger server 10A obtains code for smart contract CB2. The code for smart contract CB2 may be obtained by ledger server 10A generating the code or by ledger server 10A receiving the code transmitted from terminal 20A in response to an operation made by a person in charge of company A.

In step S109A, processor 11 of ledger server 10A generates transaction data TB2. Transaction data TB2 generated includes the code for smart contract CB2 obtained in step S108A (see FIG. 13), and the signature that is to be given to transaction data TA, which is received from ledger server 10C in step S107A, is set as an argument of the initialization function in transaction data TB2.

In step S110, similarly to the case in Embodiment 1, processor 11 of ledger server 10A generates a signature for transaction data TB2 generated in step S109A, gives the signature to transaction data TB2, and transmits transaction data TB2 to ledger server 10C.

In step S111, similarly to the case in Embodiment 1, processor 11 of ledger server 10C gives a signature to transaction data TB2 transmitted in step S110, and transmits transaction data TB2 to each of ledger servers 10A and 10B. Accordingly, all ledger servers 10A to 10C are in a state of having transaction data TB2 to which the signatures of ledger servers 10A and 10C are given.

In step S112A, similarly to step S112 in Embodiment 1, each of ledger servers 10A to 10C stores (transmitted) transaction data TB2 to which the signature is additionally given in step S111, into the distributed ledger.

Each of processors 11 of ledger servers 10A to 10C executes the initialization function in smart contract CB2 in response to transaction data TB2 being stored into the distributed ledger in step S112A, to perform step S113 and step S114A as below.

In step S113, processors 11 of ledger servers 10A to 10C each set the variable indicating a price, the variable indicating a delivery date, and the variable indicating a product delivery destination, which are stored in storage 14, to the price, the delivery date, and the product delivery destination passed to the initialization function as arguments in transaction data TB2.

In step S114A, processors 11 of ledger servers 10A to 10C each set the variable indicating a material delivery destination signature in smart contract CA, which is stored in storage 14, to the signature of company C.

The same processing as steps S126 to S130 in Embodiment 1 is executed (not illustrated) after step S114A is executed.

By performing the series of processes illustrated in FIG. 14, contract management system 1 can reduce an increase in power consumption of a computer system that manages contracts, while reducing the number of times transaction data is transmitted and received, by including, from the beginning, a signature of an owner who is an authorizer who determines that the material contract is valid in the transaction data corresponding to the manufacturing contract.

Note that the authorizer may be set to an arbitrary one, yet when, for example, a group of contracts is assumed to be made in a product supply chain, an authorizer may be set, for a contract out of the group of contracts, to a contractor of a contract downstream of the contract. This is because the content of an upstream contract in the supply chain gives influence onto the content of a downstream contract. More specifically, this is because the delivery date of an upstream contract in the supply chain often gives influence onto the delivery date of a downstream contract, and the price in an upstream contract in the supply chain often gives influence onto the price in a downstream contract.

For example, in the supply chain illustrated in FIG. 1, an authorizer who determines that the material contract is valid may be set to company C for a reason that the manufacturing contract made between company A and company C is downstream of the material contract made between company A and company B.

A description is given using a more complicated supply chain as an example.

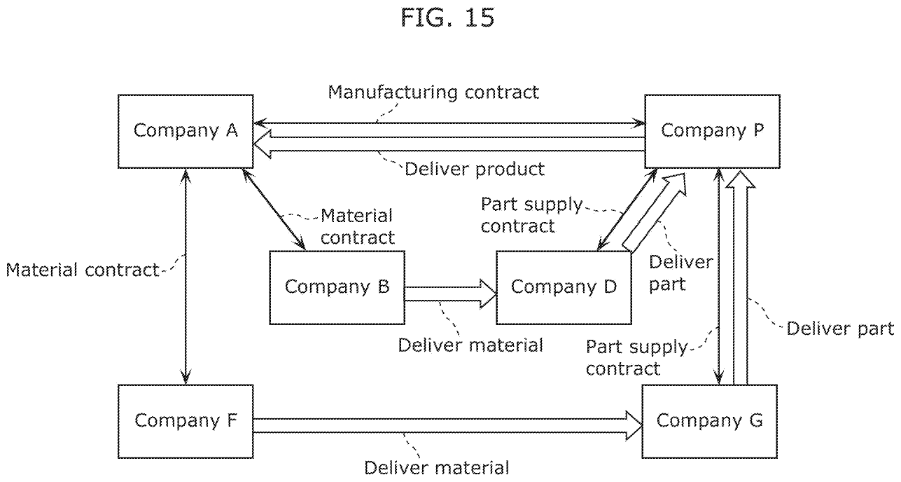

FIG. 15 is an explanatory drawing illustrating a variation of a supply chain.

In the supply chain illustrated in FIG. 15, company A that is a seller of a product makes a material contract with each of company B and company F that are material makers. The material delivery destination for company B is company D, whereas the material delivery destination for company F is company G.

On the other hand, company A that is a seller makes a manufacturing contract with company P that is a product maker. Company P makes a part supply contract related to supply of parts used for the product with each of company D and company G. Company P manufactures the product using the parts delivered from company D and company G, and delivers the product to company A.

In such a supply chain, for example, the authorizer of the material contract made between company A and company B may be set to company D that is a contractor of the part supply contract or company P that is a contractor of the manufacturing contract, which are downstream of the material contract. Similarly, the authorizer of the part supply contract made between company D and company P may be set to company A that is a contractor of the manufacturing contract that is downstream of the part supply contract.

In addition, for example, the authorizer of the material contract made between company A and company F may be set to company G that is a contractor of the part supply contract or company P that is a contractor of the manufacturing contract, which are downstream of the material contract. Similarly, the authorizer of the part supply contract made between company G and company P may be set to company A that is a contractor of the manufacturing contract that is downstream of the part supply contract.

### Supplement

Blockchains in the above embodiments and variations are to be supplementally described.

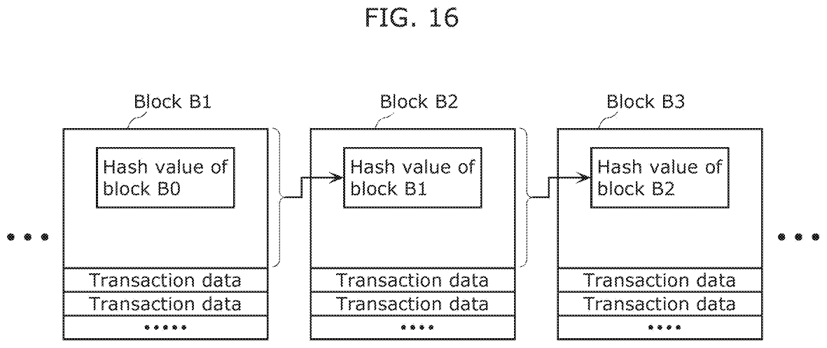

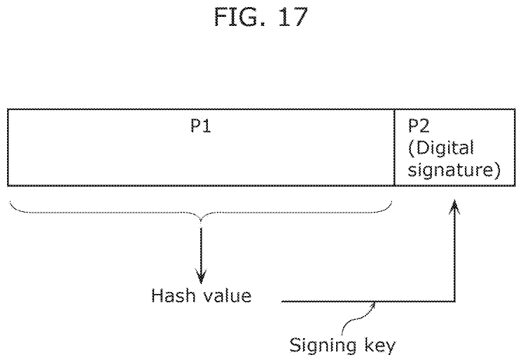

FIG. 16 is an explanatory drawing illustrating a data structure of a blockchain.

A blockchain is formed into a chain constituted by connecting blocks that are recording units. Each block includes a plurality of transaction data items and a hash value of a previous block. Specifically, block B2 includes a hash value of previous block B1. A hash value calculated from a plurality of transaction data items included in block B2 and the hash value of block B1 is included in block B3 as a hash value of block B2. In this manner, blocks are connected into a chain with the content of a previous block being included as a hash value, so that manipulation of recorded transaction data is effectively prevented.

If past transaction data is changed, the hash value of a block becomes different from the value before being changed. Thus, in order to make the manipulated block appear valid, it is necessary to recreate all the blocks after the manipulated block, and this work is extremely difficult from the practical view. Difficulty in manipulation of a blockchain is ensured using such a feature.

FIG. 17 is an explanatory drawing illustrating a data structure of transaction data.

Transaction data illustrated in FIG. 17 includes transaction body P1 and digital signature P2. Transaction body P1 is a data body included in the transaction data. Digital signature P2 is generated by adding a signature to the hash value of transaction body P1 using a signing key of a creator of the transaction data, or more specifically, by encrypting data using the signing key of the creator.

Transaction data has digital signature P2, and thus it is substantially impossible to manipulate such transaction data. Accordingly, manipulation of a transaction body can be prevented.

Note that in the above embodiments, each of the elements may be acquired using dedicated hardware, or may be obtained by executing a software program suitable for the element. Each element may be acquired using a program executor such as a CPU or a processor reading and executing a software program recorded on a recording medium such as a hard disk or semiconductor memory. Here, the software that acquires, for instance, the contract management system in the above embodiments is a program as below.

Specifically, the program causes a computer to execute a control method executed by a device out of a plurality of devices each having a distributed ledger in a contract management system that includes the plurality of devices, the control method including: obtaining first transaction data that includes a first variable indicating an authorizer having authority to determine that a first contract made between a first user and a second user is valid, the first variable being set to a predetermined value indicating that the authorizer is undetermined; storing the first transaction data obtained into the distributed ledger; executing storing processing of reading out the predetermined value included as the first variable in the first transaction data stored in the distributed ledger, and storing the predetermined value into a storage included in the device, the storage being rewritable; obtaining second transaction data that includes a change command for changing the first variable to identification information of a third user; storing the second transaction data obtained into the distributed ledger; executing change processing of changing, according to the change command, the first variable stored in the storage, after the second transaction data is stored into the distributed ledger; obtaining third transaction data that includes a fulfillment command for executing fulfillment processing of fulfilling the first contract; storing the third transaction data obtained into the distributed ledger; and executing the fulfillment processing according to the fulfillment command when the first variable stored in the storage is determined to be other than the predetermined value, after the third transaction data is stored into the distributed ledger.

The above has given a description of the contract management system and others according to one or more aspects, based on the embodiments, yet the present disclosure is not limited to these embodiments. The scope of one or more aspects may also encompass embodiments as a result of adding, to the embodiments, various modifications that may be conceived by those skilled in the art, and embodiments obtained by combining elements in different embodiments, as long as the resultant embodiments do not depart from the gist of the present disclosure.

### INDUSTRIAL APPLICABILITY

The present disclosure is applicable to a contract management system that manages contracts.

1. A control method executed by a device out of a plurality of devices each having a distributed ledger in a contract management system that includes the plurality of devices, the control method comprising:
obtaining first transaction data that includes a first variable indicating an authorizer having authority to determine that a first contract made between a first user and a second user is valid, the first variable being set to a predetermined value indicating that the authorizer is undetermined;
storing the first transaction data obtained into the distributed ledger;
executing storing processing of reading out the predetermined value included as the first variable in the first transaction data stored in the distributed ledger, and storing the predetermined value into a storage included in the device, the storage being rewritable;
obtaining second transaction data that includes a change command for changing the first variable to identification information of a third user;
storing the second transaction data obtained into the distributed ledger;
executing change processing of changing, according to the change command, the first variable stored in the storage, after the second transaction data is stored into the distributed ledger;
obtaining third transaction data that includes a fulfillment command for executing fulfillment processing of fulfilling the first contract;
storing the third transaction data obtained into the distributed ledger; and
executing the fulfillment processing according to the fulfillment command when the first variable stored in the storage is determined to be other than the predetermined value, after the third transaction data is stored into the distributed ledger.

2. The control method according to claim 1,
wherein in executing the fulfillment processing, the fulfillment processing is executed according to the fulfillment command when the first variable stored in the storage is determined to be set to the identification information of the third user as the authorizer, after the third transaction data is stored into the distributed ledger.

3. The control method according to claim 1,
wherein the first variable further includes a digital signature of the authorizer that is to be given to the first transaction data, and
in executing the fulfillment processing, the fulfillment processing is executed according to the fulfillment command when the digital signature included in the first variable stored in the storage is successfully verified, after the third transaction data is stored into the distributed ledger.

4. The control method according to claim 1,
wherein the first transaction data includes first contract code that includes the first variable and a storing command for storing the first variable into the storage, and
the storing processing is performed by a contract executor included in the device executing the storing command included in the first contract code, in response to the first transaction data being stored into the distributed ledger.

5. The control method according to claim 3,
wherein the first transaction data includes first contract code that includes the first variable and a storing command for storing the first variable into the storage,
the storing processing is performed by a contract executor included in the device executing the storing command included in the first contract code, in response to the first transaction data being stored into the distributed ledger,
the first contract code includes a signature setting function for assigning the digital signature stored as the first variable in the storage, and
when fourth transaction data that includes a command for setting the first variable to the digital signature of the authorizer by executing the signature setting function is obtained, the change processing is performed by the contract executor executing the signature setting function, in response to the fourth transaction data obtained being stored into the distributed ledger.

6. The control method according to claim 1,
wherein the second transaction data includes second contract code that includes the change command, and
the change processing is performed by a contract executor included in the device executing the change command, in response to the second transaction data being stored into the distributed ledger.

7. The control method according to claim 1,
wherein the first transaction data includes a digital signature of the first user and a digital signature of the second user, and
in storing the first transaction data into the distributed ledger, the first transaction data is stored into the distributed ledger when the digital signature of the first user and the digital signature of the second user that are included in the first transaction data are both successfully verified.

8. The control method according to claim 1, further comprising:
obtaining fifth transaction data that includes a second variable related to a second contract made between the first user and the third user; and
storing the fifth transaction data obtained into the distributed ledger,
wherein the second transaction data is provided in response to the fifth transaction data being stored into the distributed ledger.

9. The control method according to claim 8,
wherein the first contract includes a contract that stipulates that the first user is to purchase material from the second user, and the material purchased is to be delivered to a predetermined delivery destination by a predetermined deadline,
the second contract includes a contract that stipulates that the third user is to manufacture a product from the material delivered from the second user, and deliver the product to the first user,
the fifth transaction data includes a plurality of second variables each of which is the second variable, and
the plurality of second variables include a variable indicating a purchase price of the product, a variable indicating a deadline for delivering the product, and a variable indicating a delivery destination of the product.

10. A device out of a plurality of devices each having a distributed ledger in a contract management system that includes the plurality of devices, the device comprising:
a processor;
a ledger storage that stores therein the distributed ledger;
an executor; and
a storage that is rewritable,
wherein the processor obtains first transaction data that includes a first variable indicating an authorizer having authority to determine that a first contract made between a first user and a second user is valid, and stores the first transaction data obtained into the distributed ledger, the first variable being set to a predetermined value indicating that the authorizer is undetermined,
the executor executes storing processing of reading out the predetermined value included as the first variable in the first transaction data stored in the distributed ledger, and storing the predetermined value into the storage that is rewritable,
the processor further obtains second transaction data that includes a change command for changing the first variable to identification information of a third user, and stores the second transaction data obtained into the distributed ledger,
the executor further executes change processing of changing, according to the change command, the first variable stored in the storage, after the second transaction data is stored into the distributed ledger,
the processor further obtains third transaction data that includes a fulfillment command for executing fulfillment processing of fulfilling the first contract, and stores the third transaction data obtained into the distributed ledger, and
the executor further executes the fulfillment processing according to the fulfillment command when the first variable stored in the storage is determined to be other than the predetermined value, after the third transaction data is stored into the distributed ledger.

11. A non-transitory computer-readable recording medium having recorded thereon a program for causing a computer to execute the control method according to claim 1.
